(19) United States
(12) Patent Application Publication
(10) Pub. No.: US 2011/0210065 A1
(43) Pub. Date: Sep. 1, 2011

(54) Device and Method for Treating Water Involving a Filtration Through At Least One Submerged Membrane

(75) Inventors: Thomas Thouvenot, Maisons Laffitte (FR); Patricia Grelier, Sartrouville (FR); Line Fournier, Eaubonne (FR); Emmanuel Trouve, Barberaz (FR)

(73) Assignee: Veolia Water Solutions & Technologies Support, Saint Maurice (FR)

(21) Appl. No.: 13/128,313

(22) PCT Filed: Nov. 6, 2009
(86) PCT No.: PCT/FR2009/052143

§ 371 Date: May 9, 2011

(30) Foreign Application Priority Data
Nov. 7, 2008 (FR) 0857593

(51) Int. Cl. C02F 3/00

(52) U.S. Cl. 210/601; 210/202

(57) ABSTRACT

The invention relates to a device and a method for treating water to be treated, said method involving a filtration through at least one membrane coupled to an activated sludge reaction chamber, characterised in that added particles are present in at least one volume of activated sludge in contact with the membrane and in that variations in a flow generated in said volume of activated sludge parallel to the membrane are applied, enabling the creation of a level of average turbulent intensity greater than that corresponding to a constant flow in the immediate proximity of the membrane.

The present invention relates to a method for treating water and to an associated device.

Water treatment methods are known that employ coupling between an activated biological sludge reactor and a microfiltration or ultrafiltration membrane. Such biological reactors coupled to a membrane are commonly referred to as Membrane BioReactors (MBR).

Activated sludges eliminate pollutants containing carbon, nitrogen and phosphorus. The flat or organic hollow fiber membrane is generally submerged directly in the activated sludge and typically has pores with a dimension between 0.05 μm and 0.5 μm. Before filtration the liquids (known as mixed liquor) may have a concentration of the order of 10 g/L of material in suspension. The membranes separate activated sludge and purified water. After treatment the effluents are evacuated by aspiration or by gravity.

Known devices unfortunately suffer from fouling of the membranes during operation. This fouling is caused by a deposit, commonly referred to as “cake”, of colloidal or macromolecular biosolids, which leads to a loss of permeability.

Fouling can be partly controlled by applying to the device backwashing phases in which water flows in contraflow. In known methods a dedicated aeration device is also used to reduce fouling under stationary conditions. Such aeration devices consume a great deal of energy, which constitutes a major drawback.

With known devices, it is also frequently necessary to clean the membranes with chemical agents, which involves closing down the installation for a period that may be considered too long for economic or operational reasons. The use of oxidizing chemical agents such as sodium hypochlorite also constitutes a complication from the environmental point of view.

The document JP 63-214177 (application 6247210) discloses a water treatment system using a membrane bio-reactor, the membranes being integrated into the activated sludge tank, into which are introduced particles of the same hardness as the separation membrane or lower hardness.

The particles have a specific gravity greater than 1 and a diameter between 1 and 2 mm. The volume occupied by the particles is from 10 to 50% of the volume of the membrane tank. The particles are of resin, gel or polyvinyl alcohol gum, or in some cases ceramic or granular activated carbon. They are agitated or held in suspension by a stream of liquid and gas in the membrane tank with a speed of from 1 up to a few m·s⁻¹. In one case, the particles are in suspension in a fluidized bed.

The document “Granulate-driven fouling control in a submerged membrane module for MBR application” (World Water Congress Vienna 7-12 Sep. 2008) discloses a membrane bioreactor in which the membranes are integrated into the activated sludge tank. Non-porous and biologically resistant particles are introduced into the sludge at a rate of 5 kg/m³. These particles have a density between 1 and 1.5 kg/dm³ and are moved upward by a flow of air and liquid and descend by gravity. The device uses membranes separated from each other by a distance of 8 mm with polymer particles of less than 5 mm diameter. It is found that the particles damage the membranes.

Present day solutions thus make it obligatory to consume a great deal of energy or to change the membranes frequently. There is therefore a need for a solution for reducing the energy consumption of existing devices and more precisely for reducing fouling in operation, in particular without having to feed air to the membranes. The solution must also preserve the service life of the membranes by preventing any untimely damage.

To solve at least one of the problems referred to above, the present invention proposes a method of treating water to be treated involving filtration through at least one membrane coupled to an activated sludge reactor, characterized in that added particles are present in at least a volume of activated sludge in contact with the membrane and in that variations of a flow rate generated in said volume of activated sludge parallel to the membrane are applied thanks to which there is created in the immediate vicinity of the membrane a mean turbulent intensity level greater than that corresponding to a constant flow rate.

The expression added particles refers to particles that are not initially present in the water to be treated.

This method makes it possible to preserve a high permeability of the membranes and therefore to save energy by dispensing with aeration devices and cleaning steps necessitating shutting down the installation.

According to one feature, the flow rate variations are applied to create an alternation of turbulent intensity levels or a mean turbulent intensity level greater than that corresponding to a constant flow rate.

An unsteady state is created at the membrane, leading to destabilization of the cake that has accumulated on the membrane, which makes it possible to maintain the permeability of the membrane at a high level.

According to one advantageous feature, the variations of a flow rate comprise the alternation of at least a “low flow rate” first phase and a “high flow rate” second phase.

In one embodiment, the flow rate variations include an alternation of at least a first phase and a second phase, the flow rate during the first phase corresponding to a mean tangential speed between 0.01 and 0.1 ms⁻¹ applied for between 0 and 600 s, preferably between 10 and 45 s.

During a second phase the flow rate advantageously corresponds to a mean tangential speed between 0.1 and 0.35 ms⁻¹ applied for between 0 and 3600 s, preferably for between 25 and 600 s.

The first phase preferably has between 0.75 and 1.25 times the duration of the second phase.

The ratio between the high flow rate and the low flow rate is preferably between 1.5 and 12, more preferably between 2 and 3.5.

According to a beneficial and advantageous feature the particles are agitated in a fluidized bed. This has the advantage of making it possible to save energy compared to a device using an aeration system.

The membrane is preferably confined so as to channel the overall movement of said volume of activated sludge. This advantageously makes it possible to minimize the energy needed to generate the flow rate.

In one advantageous embodiment the flow rate variations are generated by a recirculation flow rate control device.

In preferred embodiments some particles have a specific gravity between 1 and 10, preferably between 1.5 and 3, and some particles have a form factor between 1 and 20, preferably between 1 and 7.

Some particles preferably essentially comprise an organic, mineral or composite material and in one particularly advantageous embodiment the particles are glass balls. Using glass balls with tangential speeds as defined above has the advantage of preserving the integrity of the surface of the membranes.

Moreover, at least some particles preferably have a diameter between 0.05 and 0.6 times the diameter of a liquid stream. Here the liquid stream diameter concept extends from the smallest distance between two walls of the liquid stream.

The filling rate by volume of the membrane tank with particles is advantageously between 0.5 and 50%, preferably between 20 and 40%.

In one embodiment at least one membrane is a flat membrane. In another embodiment at least one membrane is a hollow fiber membrane.

In one embodiment at least one membrane is placed vertically or substantially vertically.

In some embodiments at least one membrane is in a compartment integrated into the biological reactor. Instead of this or in combination with this, at least one membrane is in a dedicated compartment outside the biological reactor.

Another aspect of the invention proposes a method of treating water to be treated involving filtration through at least one membrane coupled to an activated sludge reactor and the permeability of which is maintained over time, characterized in that added particles are present in at least a volume of activated sludge in contact with the membrane and in that variations of a flow rate generated in said volume of activated sludge parallel to the membrane are applied to the particles.

The advantageous features defined hereinabove with reference to the first aspect of the invention apply equally to this second aspect of the invention.

A third aspect of the invention proposes a device for treating water to be treated including at least one filter membrane coupled to an activated sludge reactor and the permeability whereof is maintained over time, characterized in that it includes means for applying to added particles present in at least a volume of activated sludge in contact with the membrane variations of a flow rate generated in said volume of activated sludge parallel to the membrane.

According to a preferred feature the variations of a flow rate are applied to create in the immediate vicinity of the membrane a mean turbulent intensity level greater than that corresponding to a constant flow rate.

There is also proposed a device for treating water to be treated including at least one membrane coupled to an activated sludge reactor, characterized in that it includes means for applying to added particles present in at least a volume of activated sludge in contact with the membrane variations of a flow rate generated in said volume of activated sludge parallel to the membrane, thanks to which the variations of a flow rate are applied to create in the immediate vicinity of the membrane a mean turbulent intensity level greater than that corresponding to a constant flow rate.

It is emphasized that the various advantageous features defined hereinabove with reference to the first aspect of the invention apply equally to the third and fourth aspects of the invention.

The invention is described in detail next with reference to the appended figures.

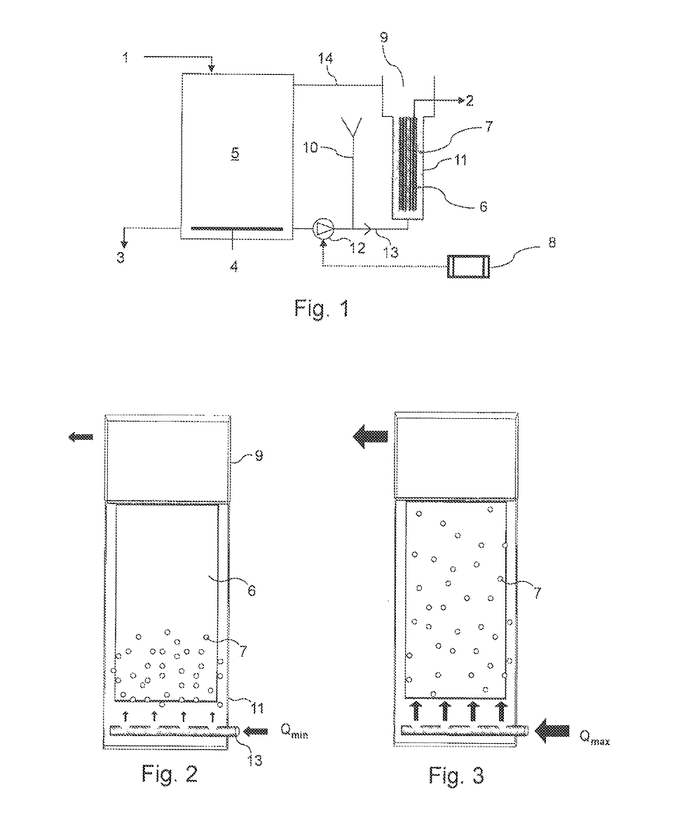

FIG. 1 is a diagram of a first embodiment of a device of the invention.

FIG. 2 is a detail view of the device from the preceding figure during a first phase of operation.

FIG. 3 is a view similar to that of FIG. 2 of the same device during a second phase of operation.

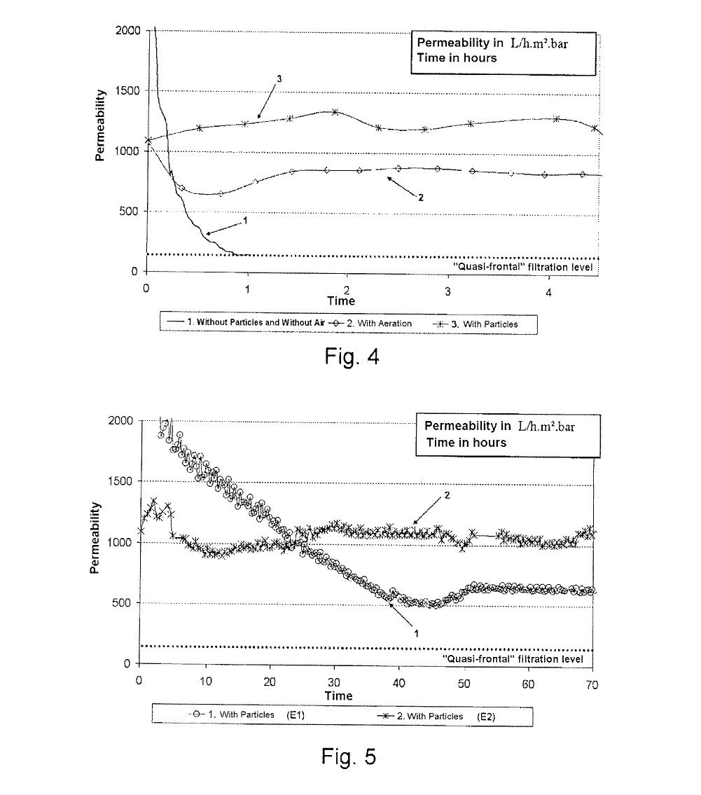

FIG. 4 is a set of permeability curves measured experimentally under different conditions using the device of the first embodiment.

FIG. 5 is also a set of permeability curves measured experimentally under different conditions using the device of the first embodiment, on a longer time scale.

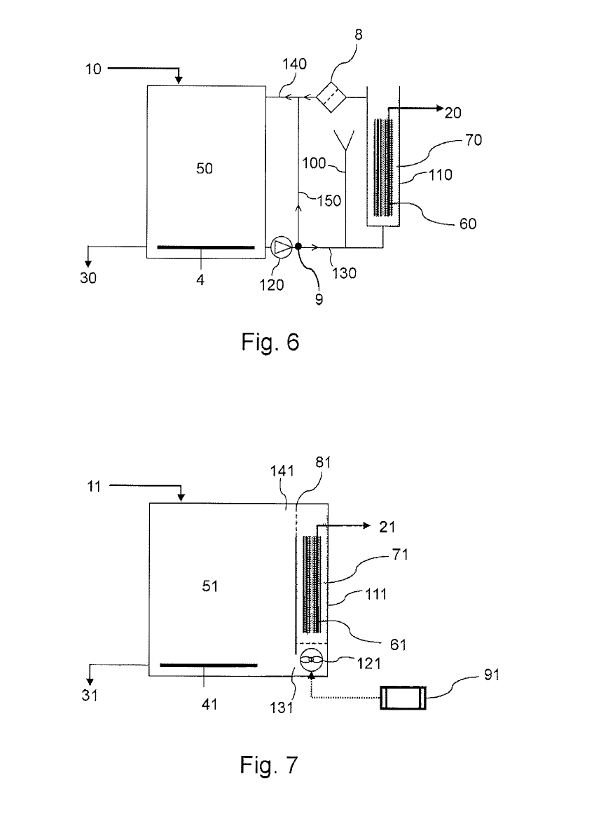

FIG. 6 is a diagram of a device of a second embodiment of the invention.

FIG. 7 is a diagram of a device of a third embodiment of the invention.

Referring to FIG. 1, a biological reactor 5 is coupled to a system 6 with two membranes in a manner known in itself, the membranes being confined in a tank 11 called the membrane tank. The number of membranes depends on the use of the invention. Five membranes may typically be used.

The untreated water to be treated is introduced into the biological reactor 5, the volume of which is 300 L in this example, via an upstream inlet 1 in the upper part of the tank 5, here at a rate of 1.2 m³/d. The treated water leaves the filtration reservoir via a downstream outlet 2 in the upper part of the membrane tank 11.

The biological reactor also includes an aeration system 4 in the lower part and an excess biological sludge evacuation outlet 3, also in the lower part. The reactor 5 could alternately include a plurality of compartments, some aerated and others not.

Here the membranes 6 are flat and vertical, 0.515 m wide and 1.47 m high. The filtration area of each of these two membranes is 1.37 m². The distance between the two membranes is 7 mm.

A pump 12 controlled by a controller 8 and a particle introduction inlet 10 are installed on the outlet 13 from the biological reactor 5 to the membrane tank 11. This outlet 13 connects the lower part of the biological reactor 5 to the lower part of the membrane tank 11. The pump 12 operates with a flow rate of 6 m³/h during a first phase and then of 12 m³/h during a second phase, the controller 8 alternating the two phases.

The pumped sludge is mixed with particles 7 in the membrane tank 11, the particles 7 being present in a proportion between 3 and 30% of the usable volume of the membrane tank, according to the use. Here the particles 7 are glass balls with a form factor of 1, a diameter of 2 mm and a specific gravity of 2.6.

A manifold 9 installed on the recirculation outlet 14 from the membrane tank 7 to the biological reactor 5 connects the upper part of the membrane tank 7 to the upper part of the biological reactor 5. The manifold 9 serves as a system for separating particles and biological sludge. In the embodiment shown, this manifold 9 is installed on the upper part of the membrane tank, at the entrance to the recirculation outlet.

The membrane tank 11 has a confinement unfavorable to fouling of the membranes 6. It includes complete confinement of the liquid stream delimited by the membrane with minimum dead volume. The usable volume of the membrane tank is 200 L.

FIG. 2 shows a front view of a membrane 6 in the membrane tank 11. The outlet 13 from the biological reactor 5 to the membrane tank 11 injects into the bottom of the membrane tank 11 at an upward flow rate Qₘᵢₙ activated sludge taken from the biological reactor 5. Here four injection orifices are shown disposed regularly at the top of a pipe 5 disposed at the bottom of the membrane tank at a height less than that of the bottom of the membrane 6.

The particles 7 are confronted with an upward flow of liquid and sludge and move differently in the liquid near and in contact with the membrane 6.

The FIG. 2 view represents an equilibrium configuration in which the mass formed by all of the particles is globally stable, some particles moving upward, others downward.

Note that with the flow rate Qₘᵢₙ represented in FIG. 2, the particles are present in a small lower half of the membrane tank while the upper half of the membrane tank is practically devoid of particles.

Finally, the upper part of the membrane tank 11 discharges into a manifold 9 which in this embodiment is a calming area resulting from sudden widening of the tank. Excess liquid flows via the manifold 9 to rejoin the recirculation outlet 14 represented in FIG. 1.

Referring to FIG. 3, there is shown the same front view of the membrane tank. This time the flow rate injected is greater than Qₘᵢₙ and reaches a value Qₘₐₓ, which in the embodiment shown is equal to twice the value Qₘᵢₙ.

The particles 7 are present throughout the height of the membrane tank because the flow rate is sufficient to raise one or more particles to the top of the tank. The flow rate Qₘₐₓ supplied in the FIG. 3 configuration is nevertheless sufficiently weak for the particles to be almost uniformly distributed over all of the height of the membrane tank, gravity being sufficient to cause some to descent toward the bottom of the tank.

There is likewise shown here an equilibrium configuration, the mass formed by all the particles being globally immobile. Excess liquid flows via the manifold 9 and rejoins the recirculation outlet 14 at a higher flow rate than in the configuration represented in FIG. 3. Some particles 7 reach the manifold 9 but are retained by it and then fall under their own weight into the membrane tank 11.

FIG. 4 represents the measured evolution under three different operating regimes of the permeability of the membrane system as a function of time over a period of 4 hours from starting up the system. The measurements are effected at 20 C. and the permeability values are given per m² of membrane. The FIG. 1 device is equipped with five membranes 0.515 m wide confined laterally, the membrane tank 7 having a total liquid stream area of 0.021 m².

In curve 1, the FIG. 1 device operates without particles and without aeration at the level of the membranes. Note that the permeability, initially close to 2000 L/h·m²·bar, falls rapidly, to a value of approximately 100 L/h·m²·bar after one hour of operation. The permeability then remains close to this latter value, referred to as a quasi-frontal filtration level.

Curve 2 shows the evolution observed in the prior art with aeration at a flow rate of 0.6 Nm³ of air (Normo meter cube of air) per m² of membrane. The permeability begins at a value close to 1000 L/h·m²·bar and then evolves to a value around 800 L/h·m²·bar, greater than the quasi-frontal filtration level by a factor of approximately 7.

Curve 3 shows the evolution of the permeability obtained using the invention. The test is effected with a 30% by volume rate of filling of the membrane tank with particles and with alternation between a 30 second phase of a flow rate of 6 m³/h corresponding to a tangential speed of 0.08 m·s⁻¹ and a 30 second phase at a flow rate of 12 m³/h, corresponding to a tangential speed of 0.15 m·s⁻¹. Starting at a value close to 1000 L/h·m²·bar, the permeability evolves to a value of approximately 1300 L/h·m²·bar, around which value it stabilizes.

FIG. 5 represents the evolution of the permeability of the membrane over longer periods of up to 70 hours. Two regimes are represented.

Curve 1 represents a test with a particle filling rate of 3% of the volume of the membrane tank and a flow rate of 6 m³/h for a 30 second phase followed by a flow rate of 12 m³/h for a 230 second phase. With these parameter values, it is found that the permeability falls to a value of 600 L/h·m²·bar, i.e. approximately 6 times the quasi-frontal permeability value. The turbulent intensity at the membrane is 17%.

Curve 2 represents a test with a 30% by volume rate of filling of the membrane tank with glass balls and alternation between a 30 second phase at a flow rate of 6 m³/h corresponding to a tangential speed of 0.08 m·s⁻¹ and a 30 second phase at a flow rate of 12 m³/h corresponding to a tangential speed of 0.15 m·s⁻¹.

With these parameter values, which constitute the preferred embodiment of the invention, the permeability is maintained at a value of 1100 L/h·m²·bar, i.e. 11 times the quasi-frontal permeability value. The turbulent intensity at the membrane averaged over about ten cycles is 42%.

FIG. 6 shows a device of another embodiment of the invention. A biological reactor 50 is coupled to a system 60 known in itself with two membranes confined in a membrane tank 110.

The untreated water to be treated is introduced into the biological reactor 50 via an upstream inlet 10 in the upper part of the reservoir 50. The treated water leaves the filtration reservoir via a downstream outlet 20 in the upper part of the membrane tank 110.

As in the first embodiment, the biological reactor also has in the lower part an aeration system 40 and an excess biological sludge evacuation outlet 30.

A pump 120 is installed on the outlet 130 from the biological reactor 50 to the membrane tank 110. This outlet 130 connects the lower part of the biological reactor 5 to the lower part of the membrane tank 11. The pump operates under a continuous regime, in contrast to that used in the first embodiment. Downstream of the pump 120 is installed a bypass system making it possible to orient part of the flow rate generated by the pump 120 from the outlet 130 to an outlet 150 feeding surplus liquid to the upper part of the biological reactor 5.

Moreover, a particle introduction inlet 100 is installed on the outlet 130. Thus the pumped liquid is mixed with particles 70 in the membrane tank 110.

A grid 80 is installed on the recirculation outlet 140 from the membrane tank to the biological reactor, which connects the upper part of the membrane tank to the upper part of the biological reservoir. The grid 80 has a mesh size smaller than the minimum diameter of the particles, for example equal to 0.8 times the diameter of the particles. This grid 80 serves as a system for separating particles and biological sludge, the particles returning to the membrane tank 110 under gravity.

FIG. 7 shows another embodiment that uses a filtration reservoir integrated into the biological sludge tank. A biological reactor 51 is coupled to a system 61 known in itself with two membranes confined in a membrane tank 111 integrated into the biological reactor 51.

The untreated water to be treated is introduced into the biological reactor 51 via an upstream inlet 11 in the upper part of the reservoir 51. The treated water leaves the filtration reservoir via a downstream outlet 21 in the upper part of the membrane tank 111.

As in the previous embodiments, the biological reactor has in the lower part an aeration system 41 and an excess biological sludge evacuation outlet 31.

A surge generator 121 is installed in the lower part of the membrane tank 111, near a communicating pipe 131 between the main space of the biological reactor 51 and the membrane tank. This pipe 131 connects the lower part of the biological reactor 51 to the lower part of the membrane tank 111. The surge generator is controlled by a controller 91.

The liquid present in the membrane tank is brought into the presence of particles 71 in contact with the membranes of the system 61.

A grid 81 is installed in the recirculation area 141 extending from the upper part of the membrane tank 111 to the upper part of the biological reactor 51. The grid 81 serves as a system for separating particles and biological sludge, the particles returning to the membrane tank 111 under gravity.

In another embodiment that is not shown, the system uses filtration elements in the form of hollow fibers.

It will be noted that here the surge generator 91 is a pump and that, in the various embodiments, it may instead be a device for controlling the recirculation flow rate, such as a valve, a hydraulic converter or a bypass system.

Where the system for separating particles and sludge is concerned, an alternative embodiment uses a hydrocyclone, the particles being recovered via an underflow and sludge via an overflow. In a further embodiment a laminar settling tank is used at the top of the membrane tank.

1-24. (canceled)

25. A method of treating water comprising:
directing the water into a biological reactor containing activated sludge and biologically treating the water with the activated sludge to form a mixed liquor;
pumping the mixed liquor from the biological reactor to a membrane filtration tank having one or more membranes therein.
filtering the mixed liquor in the membrane filtration tank with the one or more membranes to produce treated water;
adding particles to the mixed liquor and utilizing the particles in the membrane filtration tank to clean the one or more membranes therein.
varying the flow rate of the mixed liquor pumped into the membrane filtration tank between a relatively low flow rate and a relatively high flow rate and:
1. causing a turbulent flow of mixed liquor immediately adjacent the one or more membranes in the membrane filtration tank;
2. causing the particles in the membrane filtration tank to be agitated and suspended in the turbulent flow adjacent the one or more membranes; and
3. causing the agitated particles to contact the one or more membranes in the membrane filtration tank and in the process clean the one or more membranes.

26. The method of claim 25 wherein the relatively low flow rate of the mixed liquor in the membrane filtration tank is between approximately 0.01 ms⁻¹ and approximately 0.1 ms⁻¹ and is applied for between approximately 0 s and approximately 600 s.

27. The method of claim 26 wherein the relatively low flow rate is applied for between approximately 10 s and approximately 45 s.

28. The method of claim 25 wherein in the relatively high flow rate of the mixed liquor in the membrane filtration tank adjacent the one or more membranes is between approximately 0.1 ms⁻¹ and approximately 0.35 ms⁻¹ and is applied for between approximately 0 s and approximately 3600 s.

29. The method of claim 28 wherein the relatively high flow rate is applied for between approximately 25 s and approximately 600 s.

30. The method of claim 25 wherein in varying the flow rate of the mixed liquor comprises a first phase where the flow rate is relatively low and a second phase where the flow rate is relatively high and wherein the method comprises applying the first phase for between approximately 0.75 and approximately 1.25 times as long as the second phase.

31. The method of claim 25 wherein a ratio between the relatively high flow rate of the first phase and the relatively low flow rate of the second phase is between approximately 1.5 and approximately 12.

32. The method of claim 31 wherein the ratio between the relatively high flow rate and the relatively low flow rate of the mixed liquor is between approximately 2 and approximately 3.5.

33. The method of claim 25 further comprising agitating the particles in a fluidized bed.

34. The method of claim 25 wherein at least some of the particles have a specific gravity of between 1 and 10.

35. The method of claim 34 wherein at least some of the particles have a specific gravity of between 1.5 and 3.

36. The method of claim 25 wherein at least some of the particles have a form factor of between approximately 1 and approximately 20.

37. The method of claim 36 wherein at least some of the particles have a form factor of between approximately 1 and approximately 7.

38. The method of claim 25 wherein at least some of the particles comprise an organic material or mineral material.

39. The method of claim 25 wherein at least some of the particles comprise glass.

40. The method of claim 25 further comprising filling the membrane filtration tank with the particles such that the particles take up between approximately 0.5% and approximately 50% of the volume of the membrane tank.

41. The method of claim 40 wherein the filling the membrane filtration tank with the particles such that the particles take up between approximately 20% and approximately 40% of the volume of the membrane tank.

42. The method of claim 25 wherein the particles are added to the mixed liquor at a point downstream of a pump that pumps the mixed liquor into the membrane filtration tank and upstream from the membrane filtration tank.

43. The method of claim 25 wherein filtering the mixed liquor through the one or more membranes comprises separating the activated sludge from the treated water and wherein the method further comprises recirculating the activated sludge to the biological reactor.

44. The method of claim 25 wherein adding particles to the mixed liquor comprises adding the particles to the mixed liquor downstream from the biological reactor and upstream from the membrane tank.

45. A system for treating water comprising:
a. a biological reactor for receiving water to be treated and biologically treating the water with activated sludge wherein the water and activated sludge form mixed liquor;
b. a membrane filtration tank located downstream from the biological reactor;
c. a pump for pumping mixed liquor from the biological reactor into the membrane filtration tank;
d. one or more membranes in the membrane filtration tank for filtering the mixed liquor and producing a stream of treated water;
e. a particle injection inlet for injecting particles into the mixed liquor and wherein the particles are held in the membrane filtration tank; and
f. wherein the pump is configured to vary the flow rate of mixed liquor into the membrane filtration tank between a relatively low flow rate and a relatively high flow rate such that the varying flow rate causes a turbulent flow of mixed liquor adjacent the one or more membranes in the membrane filtration tank and causes the particles to be suspended in a fluidized bed adjacent the one or more membranes and causes the particles to be agitated and to contact the one or more membranes so as to clean the one or more membranes and reduce membrane fouling.

46. The system of claim 45 further including a controller operatively connected to the pump for varying the flow rate of the pump and for causing the particles to be agitated and to contact the one or more membrane of the membrane filtration tank.

47. The system of claim 45 wherein the pump is configured to create in the immediate vicinity of the one or more membranes a mean turbulent intensity level greater than that corresponding to a constant flow rate.

48. The system of claim 45 wherein the pump is configured so as to alternate between first and second phases wherein the flow rate during the first phase corresponds generally to a mean tangential speed between 0.01 ms⁻¹ and 0.1 ms⁻¹ applied for 10 seconds or more and wherein during the second phase the flow rate corresponds to a mean tangential speed between 0.1 ms⁻¹ and 0.35 ms⁻¹ applied for more than 25 seconds.
